(19) United States
(12) Patent Application Publication
(10) Pub. No.: US 2008/0140274 A1
(43) Pub. Date: Jun. 12, 2008

(54) Method for controlling regenerative braking of electric vehicle

(76) Inventors: Gab Bae Jeon, Gunpo-si (KR); Byeong Cheol Yang, Daegu (KR)

Correspondence Address: MORGAN, LEWIS & BOCKIUS LLP (SF), One Market, Spear Street Tower, Suite 2800, San Francisco, CA, 94105, US

(21) Appl. No.: 11/648,752

(22) Filed: Dec. 29, 2006

(30) Foreign Application Priority Data
Dec. 6, 2006 (KR) 10-2006-0122712

(51) Int. Cl. G06F 19/00

(52) U.S. Cl. 701/22; 701/70

(57) ABSTRACT

A method for controlling regenerative braking of an electric vehicle includes steps of detecting a pedal stroke generated as a brake pedal is pushed down in a regenerative braking mode, detecting a hydraulic pressure in a master cylinder of a brake system, comparing a detected value of the pedal stroke sensor with a detected value of the master cylinder hydraulic pressure, deciding a state where the detected value of the master cylinder hydraulic pressure compared with the detected value of the pedal stroke sensor is out of a reference range as a fail, suspending a regenerative braking cooperative control in which a regenerative braking and a brake hydraulic pressure control are suspended, and supplying a hydraulic pressure from a hydraulic source to a wheel cylinder of the brake system by a control of the brake hydraulic pressure controller and controlling a target wheel cylinder hydraulic pressure repeatedly with a braking force required by a driver.

### CROSS-REFERENCE TO RELATED APPLICATION

This application claims the benefit of Korean Patent Application No. 10-2006-0122712, filed on Dec. 6, 2006, the entire disclosure of which is hereby incorporated by reference.

### BACKGOUND OF THE INVENTION

1. Field of the Invention

The present invention relates to a method for controlling regenerative braking of an electric vehicle and, more particularly, to a method for controlling regenerative braking of an electric vehicle that checks whether or not the brake hydraulic system operates normally using a signal of a pedal stroke sensor.

2. Description of Related Art

In general, an electric vehicle is a vehicle that drives a motor using electric energy stored in a battery and uses the driving force of the motor as a power source wholly or partially. At present, the electric vehicle is classified into a pure electric vehicle that applies only the electric energy of the battery as the power source and a hybrid electric vehicle that includes an engine to apply the power generated from the engine to the battery charge and/or to the driving of the vehicle.

In general, an electric vehicle in braking applies a portion of braking force to the generation of electric power and uses the generated electric energy in charging the battery. Here, a portion of the kinetic energy is used as energy required for driving an electric generator, thus realizing the reduction of the kinetic energy (i.e., the reduction of the driving speed) and the generation of electric energy at the same time. This braking method is called the regenerative braking. The generation of the electric energy in the regenerative braking mode is achieved by a separate electric generator or by driving the motor reversely.

By the regenerative braking control in braking the electric vehicle, the available driving distance of the electric vehicle is increased and, in case of the hybrid electric vehicle, the fuel efficiency is improved and the generation of noxious exhaust gas is reduced as well. A hydraulic brake system that causes a braking force by the hydraulic pressure may be equipped in the electric vehicle. However, such a hydraulic brake system may not attain a sufficient braking force only with the regenerative braking force, since a desirable vehicle dynamics control cannot be obtained only with the braking force of the driving wheels as the regenerative braking force is generated in the driving wheels connected to the motor.

According to conventional regenerative braking control systems, the regenerative braking control is performed in addition to the hydraulic braking force produced as the brake pedal is operated by a driver, and the regenerative braking force is controlled in a quantity that is not related to the magnitude of the total braking force required or the magnitude of the hydraulic braking force. Thus, the braking force (the operation of the brake pedal) that the driver wants is made of the sum total of the hydraulic braking force and the regenerative braking force. Accordingly, if a desired braking force is not obtained only with the regenerative braking force, the hydraulic braking force that generates thermal energy by the frictional force of a disc and a pad is applied as much as its difference, and the regenerative braking force operates the electric generator when reducing the speed of the driving motor dedicated to the drive to generate the necessary braking force and, at the same time, the electric power generated at this time is stored in the battery.

Here, if the brake pedal is pushed down by the same force, the total braking force of the vehicle is changed based on whether or not the regenerative braking control is activated. Accordingly, there occurs a case where the driver may become confused by the speed reduction of the vehicle regardless of the degree that the user operates.

That is, the motor of the electric vehicle acts as an electric generator to produce the necessary braking forces of the whole vehicle. If the braking force control is not achieved by the motor connected with the general brake such as the existing hydraulic brake, etc., the driver cannot obtain a desired braking feel as he or she additionally feels a speed reduction as much as the braking force by the regenerative braking, and further the driver may always feel that the vehicle is suddenly stopped during the electric power generation by the motor.

To prevent such a problem, it is necessary to provide braking force cooperative control between a regenerative braking controller taking charge of the regenerative braking of the motor and the existing brake system. In a conventional system, if the brake operation of the electric vehicle is started, the regenerative braking torque is generated and the hydraulic braking torque by the hydraulic control is added thereto, thus generating a braking force that the driver wants.

U.S. Pat. No. 6,142,586 has disclosed a brake force control apparatus that detects a leak of brake fluid occurring in a state where a constant fluid is supplied to a wheel cylinder and compensates a decrease of the brake fluid through a valve control during the control for the hydraulic braking force in the regenerative braking mode.

That is, the brake force control apparatus of the above conventional art maintains the wheel cylinder pressure at a minimum reference pressure, if the braking force required by the driver would be covered only with the regenerative braking force in the regenerative braking mode. On the contrary, if the wheel cylinder pressure is lower than the minimum reference pressure, the apparatus decides such a state as a leak of brake fluid and intercepts the fluid pressure between the master cylinder and the wheel cylinder to compensate the wheel cylinder fluid pressure from a separate hydraulic source.

However, such the conventional art has some drawbacks in that it does not accurately decide the braking force required by the driver and thereby the leak of brake fluid would not be detected precisely in the regenerative braking mode.

### SUMMARY OF THE INVENTION

Embodiments of the present invention provide a method for controlling regenerative braking of an electric vehicle that checks whether or not the brake hydraulic system operates normally using a signal of a pedal stroke sensor and provides a secure braking force in a manner that a braking force required by a driver is measured by comparing a detected value of the pedal stroke sensor with a hydraulic pressure formed in a master cylinder, the regenerative braking is suspended if the hydraulic pressure of the master cylinder compared with the detected value of the pedal stroke sensor is out of a reference range, a compensation control supplying a hydraulic pressure to a wheel cylinder is carried out to make the brake operation, whereas, if the hydraulic pressure of the wheel cylinder is beyond a target hydraulic pressure, it decides the state as a leak of brake fluid to carry out the regenerative braking, if necessary.

In an exemplary embodiment of the present invention, there is provided a method for controlling regenerative braking of an electric vehicle comprising the steps of detecting, at a pedal stroke sensor, a pedal stroke generated as a brake pedal is pushed down in a regenerative braking mode; detecting, at a hydraulic pressure sensor, a hydraulic pressure in a master cylinder of a brake system; comparing, at a brake hydraulic pressure controller, a detected value of the pedal stroke sensor with a detected value of the master cylinder hydraulic pressure; deciding a state where the detected value of the master cylinder hydraulic pressure compared with the detected value of the pedal stroke sensor is out of a reference range as a fail; suspending a regenerative braking cooperative control in which a regenerative braking and a brake hydraulic pressure control are suspended; and supplying a hydraulic pressure from a hydraulic source to a wheel cylinder of the brake system by a control of the brake hydraulic pressure controller and controlling a target wheel cylinder hydraulic pressure repeatedly with a braking force required by a driver.

As a further exemplary embodiment the method for controlling regenerative braking of an electric vehicle further comprises the steps of: detecting a hydraulic pressure of the wheel cylinder and, if a detected value follows a braking force required by a driver, continuing the brake operation with a hydraulic control of the wheel cylinder; and carrying out a control for compensating the hydraulic pressure for the wheel cylinder by deciding a state where a detected value of the wheel cylinder hydraulic pressure is lower than the braking force required by the driver as a leak of brake fluid.

As another exemplary embodiment, the control for compensating hydraulic pressure is achieved by additionally supplying an insufficient hydraulic pressure for braking to a wheel cylinder in which a leak of brake fluid does not occur.

As still another exemplary embodiment, when the braking force is short even if the additional hydraulic pressure required for braking is supplied to the wheel cylinder, a control for compensating the insufficient braking force is made by performing the regenerative braking.

### BRIEF DESCRIPTION OF THE DRAWINGS

The above and other features of the present invention will be described with reference to certain exemplary embodiments thereof illustrated the attached drawings in which:

FIG. 1 is a flowchart illustrating a method for controlling regenerative braking of an electric vehicle in accordance with the present invention;

FIG. 2 is a diagram illustrating a process of measuring a braking force required by a driver in the method for controlling regenerative braking of an electric vehicle in accordance with the present invention;

FIG. 3 is a graph illustrating a relationship between a pedal stroke and a master cylinder hydraulic pressure in the method for controlling regenerative braking of an electric vehicle in accordance with the present invention; and

FIG. 4 is a graph illustrating hydraulic pressure relationships of a wheel cylinder in the method for controlling regenerative braking of an electric vehicle in accordance with the present invention.

### DETAILED DESCRIPTION OF THE INVENTION

Hereinafter, exemplary embodiments of the present invention will now be described in detail with reference to the attached drawings.

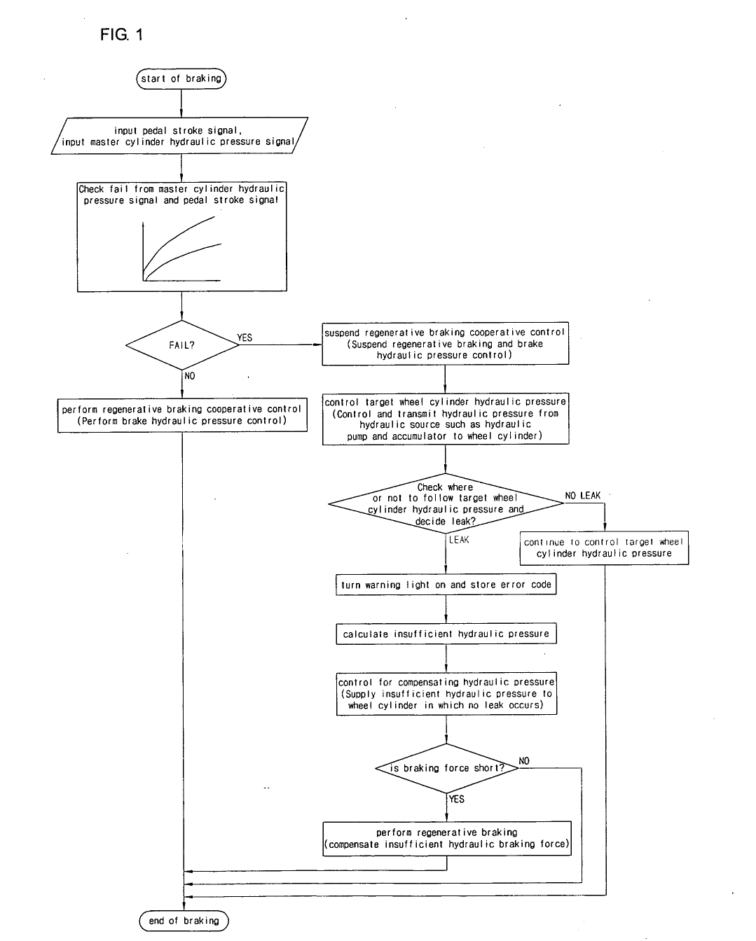

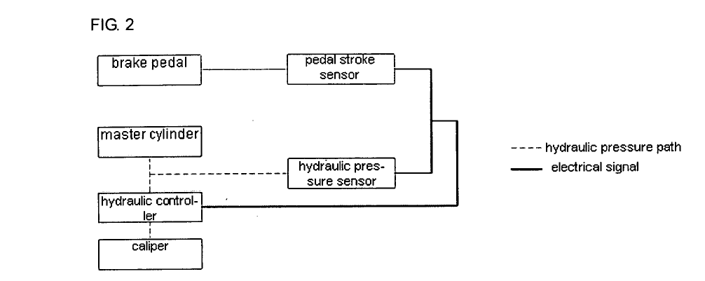

Referring first to FIGS. 1 and 2, in a regenerative braking mode of an electric vehicle, a pedal stroke sensor detects a pedal stroke caused as a brake pedal is pushed down and transmits the detected value to a brake hydraulic pressure controller, and a hydraulic pressure sensor detects a hydraulic pressure in a master cylinder of a brake system and transmits the same to the brake hydraulic pressure controller. Subsequently, the brake hydraulic pressure controller compares the detected value of the pedal stroke with the detected value of the master cylinder hydraulic pressure and, if the detected value of the master cylinder hydraulic pressure compared with the detected value of the pedal stroke sensor is out of a reference range, it decides the state as a fail.

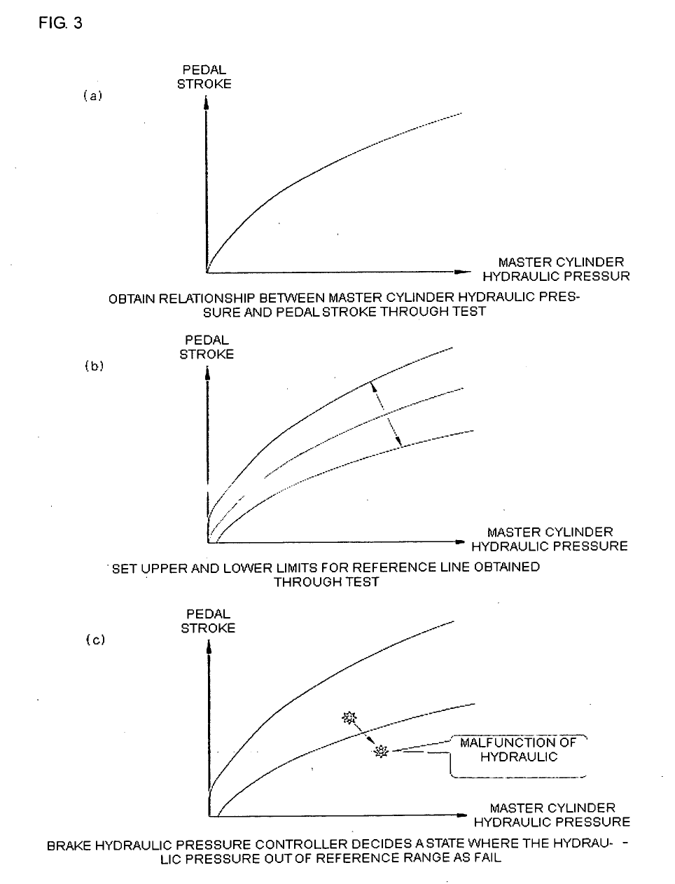

That is, as can be seen in FIG. 3, the relationship between the pedal stroke and the master cylinder hydraulic pressure is obtained through a test, upper and lower limits for a normal reference range corresponding to the relationship are set and, if the detected value of the master cylinder hydraulic pressure compared with the detected value of the pedal stroke sensor is out of the reference range as described above, the brake hydraulic pressure controller decides the state as a fail. Accordingly, a regenerative braking cooperative control is suspended, in which the regenerative braking and the brake hydraulic pressure control are suspended.

The brake hydraulic pressure controller applies a signal for stopping the motor drive of the electric vehicle to carry out the control of suspending the regenerative braking and, at the same time, supplies a hydraulic pressure from a separate hydraulic source such as a hydraulic pump or an accumulator, to the wheel cylinder of the brake system, thus achieving the brake by the hydraulic braking force. The controller may comprise a processor, memory and associated hardware and software as may be selected and programmed by persons of ordinary skill in the art based on the teachings of the present invention as set forth herein.

Subsequently, while the hydraulic pressure is supplied from the hydraulic source to the wheel cylinder of the brake system by the brake hydraulic pressure controller, a process of controlling a target wheel cylinder hydraulic pressure repeatedly with a braking force required by the driver is performed.

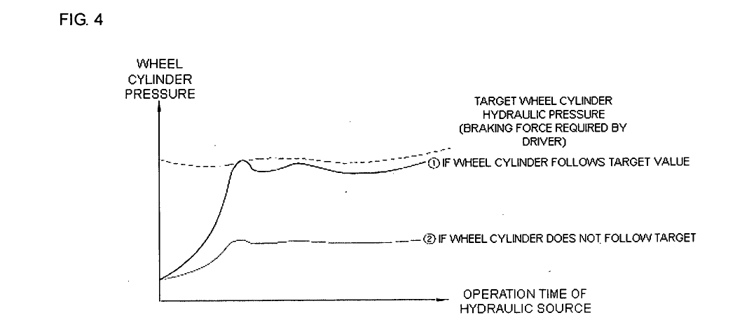

As depicted in FIG. 4, with the repeated control of the target wheel cylinder hydraulic pressure, the hydraulic pressure of the wheel cylinder is detected and, if the detected value follows the braking force required by the driver, the brake operation is made continuously by the hydraulic control of the wheel cylinder, whereas, if the detected value of the wheel cylinder hydraulic pressure is lower than the braking force required by the driver, it decides such a state as a leak of brake fluid to compensate the hydraulic pressure of the wheel cylinder.

The control for compensating the hydraulic pressure is made in a manner that an insufficient hydraulic pressure is additionally supplied to a wheel cylinder in which a leak of brake fluid does not occur, thus making the brake operation easily.

That is, if the brake fluid leaks in a wheel cylinder on one side, a desired brake cannot be made only with a wheel cylinder on the other side. Accordingly, an additional hydraulic pressure is supplied to the wheel cylinder on the other side, thus ensuring a smooth brake.

Here, when a smooth brake would not be obtained, even if the additional hydraulic pressure required for braking is supplied to the wheel cylinder, the brake hydraulic pressure controller applies a driving signal to the motor of the electric vehicle to activate the regenerative braking and thereby the insufficient braking force is compensated by the regenerative braking.

As described above, according to the method for controlling regenerative braking of an electric vehicle in accordance with the present invention, the braking force required by the driver is measured by comparing the detected value of the pedal stroke sensor with the hydraulic pressure formed in the master cylinder, the regenerative braking is suspended if the hydraulic pressure of the master cylinder for the detected value of the pedal stroke sensor is out of a reference range, a hydraulic pressure is supplied to the wheel cylinder to make the brake operation, whereas, if the hydraulic pressure of the wheel cylinder is beyond a target hydraulic pressure, it decides the state as a leak of brake fluid to carry out the regenerative braking, if necessary.

That is, the present invention has advantages in that it is possible to check whether or not the brake hydraulic system operates normally and, at the same time, provide a secure braking force.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A method for controlling regenerative braking of an electric vehicle,:
detecting, at a pedal stroke sensor, a pedal stroke generated as a brake pedal is pushed down in a regenerative braking mode;
detecting, at a hydraulic pressure sensor, a hydraulic pressure in a master cylinder of a brake system;
comparing, at a brake hydraulic pressure controller, a detected value of the pedal stroke sensor with a detected value of the master cylinder hydraulic pressure;
deciding a state where the detected value of the master cylinder hydraulic pressure compared with the detected value of the pedal stroke sensor is out of a reference range as a fail;
suspending a regenerative braking cooperative control in which a regenerative braking and a brake hydraulic pressure control are suspended; and
supplying a hydraulic pressure from a hydraulic source to a wheel cylinder of the brake system by a control of the brake hydraulic pressure controller and controlling a target wheel cylinder hydraulic pressure repeatedly with a braking force required by a driver.

2. The method for controlling regenerative braking of an electric vehicle as recited in claim 1, further comprising:
detecting a hydraulic pressure of the wheel cylinder and, if a detected value follows a braking force required by a driver, continuing the brake operation with a hydraulic control of the wheel cylinder; and
carrying out a control for compensating the hydraulic pressure for the wheel cylinder by deciding a state where a detected value of the wheel cylinder hydraulic pressure is lower than the braking force required by the driver as a leak of brake fluid.

3. The method for controlling regenerative braking of an electric vehicle as recited in claim 2, wherein the control for compensating hydraulic pressure is achieved by additionally supplying an insufficient hydraulic pressure for braking to a wheel cylinder in which a leak of brake fluid does not occur.

4. The method for controlling regenerative braking of an electric vehicle as recited in claim 3, wherein, when the braking force is short even if the additional hydraulic pressure required for braking is supplied to the wheel cylinder, a control for compensating the insufficient braking force is made by performing the regenerative braking.
